(19) United States
(12) Patent Application Publication
(10) Pub. No.: US 2002/0135301 A1
(43) Pub. Date: Sep. 26, 2002

(54) Halogen filament lamp

(76) Inventors: Klaus-Peter Knorr, Nennslingen (DE); Klaus Wittmann, Sontheim (DE)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/049,477

(22) PCT Filed: Jun. 22, 2001
(86) PCT No.: PCT/DE01/02308

(30) Foreign Application Priority Data
Jul. 19, 2000 (DE) 100 35 401.7

(51) Int. Cl. H01K 1/50

(52) U.S. Cl. 313/578

(57) ABSTRACT

The invention relates to a halogen lamp for motor vehicle headlights which has an electrical power consumption of between 50 watts and 100 watts and has at least one incandescent filament, the at least one incandescent filament (5) being formed according to the invention as a single coil, the dimensions and/or geometry of which are matched to an operating voltage of at least 20 volts, the length of the single coil being restricted to a range from 4.0 mm to 6.5 mm.

The invention relates to a halogen lamp for motor vehicle headlights according to the preamble of patent claim 1.

### I. PRIOR ART

There are commercially available halogen lamps for headlights of motor vehicles with a vehicle supply voltage of 12 volts. These halogen lamps have a power consumption of about 50-100 watts and at least one incandescent filament, the incandescent filament being singly wound and designed for an operating voltage of approximately 12 volts.

There are also commercially available halogen lamps for headlights of motor vehicles with a vehicle supply voltage of 24 volts. These halogen lamps have a power consumption of between 50 watts and 100 watts and at least one incandescent filament, the incandescent filament being doubly wound and designed for an operating voltage of at least 20 volts. To ensure adequate vibration resistance, the singly wound ends of the doubly wound incandescent filament are provided with insertion pins. Instead of an insertion pin, in each end of the singly wound filament there may remain a residual amount of the core wire which was etched out by means of acid only from the light-emitting, doubly wound region of the incandescent filament, but not out of its singly wound ends. The secondary coil of this doubly wound incandescent filament has only very few turns. The illumination which can be achieved with it has an inhomogeneous effect.

### II. SUMMARY OF THE INVENTION

It is the object of the invention to provide a halogen lamp for motor vehicle headlights with a power consumption of between 50 watts and 100 watts which can be operated on a vehicle supply voltage of 24 volts and ensures homogeneous illumination.

This object is achieved according to the invention by the features of patent claim 1. Particularly advantageous embodiments of the invention are described in the subclaims.

In the case of the halogen lamp according to the invention, the at least one incandescent filament is formed as a single coil, the dimensions and/or geometry of which are matched to an operating voltage of at least 20 volts, the length of the single coil having a value in the range from 4.0 mm to 6.5 mm. By being fitted with the single coil according to the invention and by interacting with the reflector of the motor vehicle headlight, it is possible with the halogen lamp according to the invention to achieve a more homogeneous illumination than with the aforementioned, previously customary halogen lamps. The restriction of the length of the single coil according to the invention to a range from 4.0 mm to 6.5 mm ensures by the interaction with the reflector of the motor vehicle headlight a directed light emission and a well-defined cone of light. The single coil of the halogen lamp according to the invention has three to four times the number of turns and a significantly smaller distance between the individual turns than the secondary coil of the doubly wound incandescent filament of the previously customary halogen lamps for headlights of motor vehicles with a rated vehicle supply voltage of 24 volts. The single coil of the halogen lamp according to the invention is advantageously provided with a least 20 turns, which are evenly distributed over the length of the single coil to achieve illumination which is as homogeneous as possible.

As a difference from the 12 V halogen lamps described above as prior art, the halogen lamp according to the invention has, on account of the higher operating voltage, as the incandescent filament single coil which is produced from a wire which is thinner and approximately twice as long as the single coil of the 12[lacuna] halogen lamp. To ensure a great vibration resistance in spite of the thinner wire, the ends of the incandescent filament of the halogen lamp according to the invention are advantageously provided with supporting means. Preferably suited as supporting means are supporting filaments or tubes produced from molybdenum foil or molybdenum strip which enclose the unwound ends of the single coil.

The single coil of the halogen lamp according to the invention advantageously has at least 20 turns and an outside diameter of between 1.4 mm and 2.0 mm, so that the halogen lamp according to the invention has, in spite of the comparatively long wire which is used for producing the incandescent filament, a spatially compact single coil as the incandescent filament. The diameter of the wire used for producing the incandescent filament advantageously lies between 0.11 mm and 0.14 mm, on the one hand to adapt the filament resistance to the desired power consumption of the halogen lamp according to the invention and on the other hand to make it possible for a spatially compact single coil to be used as the incandescent filament.

### III. DESCRIPTION OF THE PREFERRED EXEMPLARY EMBODIMENTS

The invention is explained in more detail below on the basis of two preferred exemplary embodiments. In the drawing:

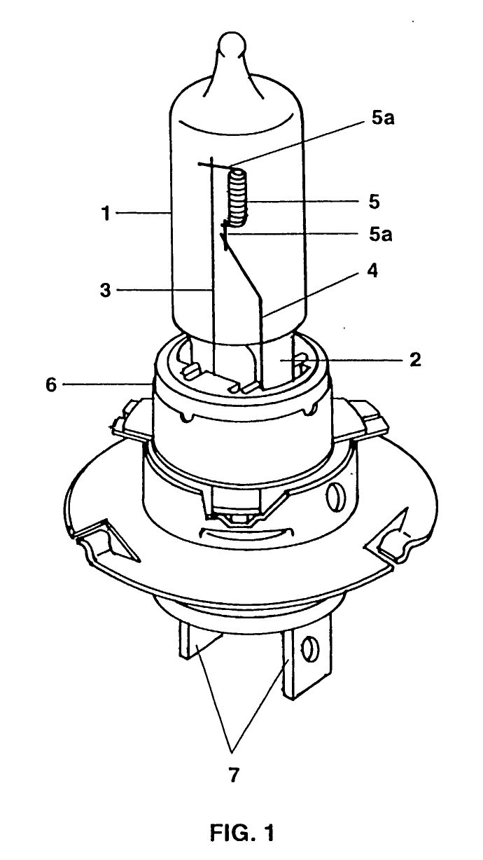

FIG. 1 shows a schematic side view of a halogen lamp according to the invention for a motor vehicle headlight with a singly wound, axially arranged incandescent filament

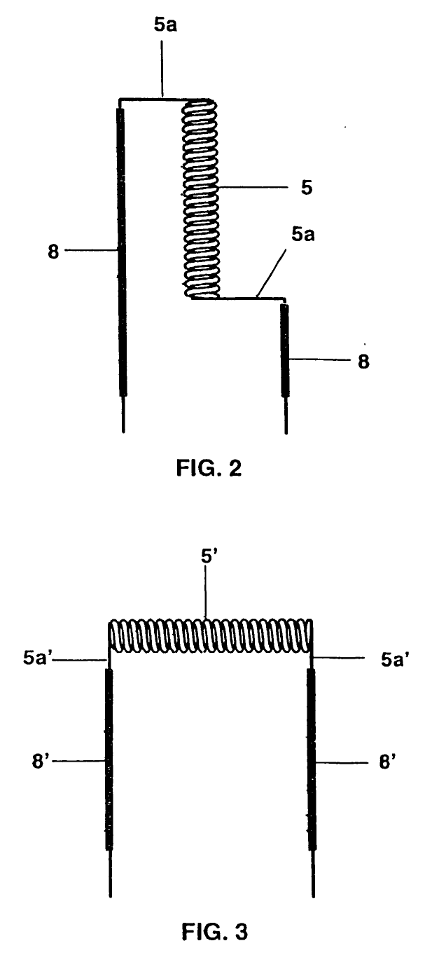

FIG. 2 shows a plan view of an axial filament according to the first exemplary embodiment of the invention in a schematic representation

FIG. 3 shows a plan view of a transversal filament according to the second exemplary embodiment of the invention in a schematic representation

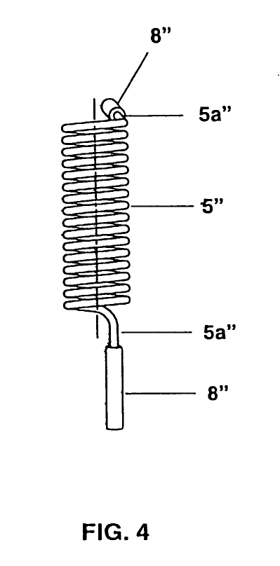

FIG. 4 shows a plan view of a single coil according to a third exemplary embodiment of the invention in a schematic representation.

The halogen lamp according to the first exemplary embodiment has an essentially cylindrical lamp vessel 1 with a gastight-sealed pinch foot 2, through which two power supply leads 3, 4 for the incandescent filament 5 arranged in the axial direction within the lamp vessel 1 are led. The pinch foot 2 is fixed in the lamp base 6, which is provided with two contact lugs 7 for supplying voltage to the incandescent filament 5. FIG. 1 schematically shows the construction of this halogen lamp. This is a halogen lamp for a motor vehicle headlight with a power consumption of approximately 70 watts, which is intended for operation on a rated vehicle supply voltage of 24 volts.

According to the first exemplary embodiment of the invention, the incandescent filament 5 is formed as a single coil which has a length of approximately 5.6 mm ±0.2 mm, an outside diameter of approximately 1.7 mm and 26 turns. The aforementioned specifications relate to the wound region of the incandescent filament 5, responsible for the light emission, without taking into account the unwound ends 5a of the incandescent filament 5. The tungsten filament wire used for producing the single coil 5 has a diameter of 0.13 mm. The effective length of the filament wire, that is to say the length of the filament wire forming the wound region of the single coil 5, is approximately 124.8 mm. The unwound ends 5a of the incandescent filament 5 are respectively provided with a covering filament 8 to improve the vibration resistance and to support the incandescent filament 5. The covering filaments 8 enclose the respective unwound ends 5a with a clamping fit. They preferably extend over the greater part of the respective unwound end 5a. In FIG. 2, the construction of the incandescent filament 5 according to the first exemplary embodiment is schematically represented.

According to the second exemplary embodiment of the invention, the incandescent filament 5′ is formed as a transversal single coil, that is to say a single coil arranged perpendicularly to the lamp axis, which has a length of approximately 5.2 mm ±0.2 mm, an outside diameter of approximately 1.9 mm and 23 turns. The aforementioned specifications relate to the wound region of the incandescent filament 5′, responsible for the light emission, without taking into account the unwound ends 5a′ of the incandescent filament 5′. The tungsten filament wire used for producing the single coil 5′ has a diameter of 0.13 mm. The effective length of the filament wire, that is to say the length of the filament wire forming the wound region of the single coil 5′, is approximately 124.9 mm. The unwound ends 5a′ of the incandescent filament 5′ are respectively provided with a covering filament 8′ to improve the vibration resistance and to support the incandescent filament 5′. The covering filaments 8′ enclose the respective unwound ends 5a′ with a clamping fit. They preferably extend over the greater part of the respective unwound end 5a′. In FIG. 3, the construction of the incandescent filament 5′ according to the second exemplary embodiment is schematically represented.

Both single filaments 5, 5′ described in more detail above are adapted on the basis of their dimensions and geometry to an operating voltage of approximately 24 volts and a power consumption of approximately 70 watts.

The single filament 5″ according to the third exemplary embodiment, depicted in FIG. 4, differs from the single filaments of the two exemplary embodiments explained above only in that the unwound ends 5a″ are respectively surrounded with a clamping fit by a tube 8″ produced from molybdenum strip. The molybdenum tubes 8″ extend in each case over the greater part of the corresponding unwound end 5a″. Furthermore, the molybdenum tubes 8″ facilitate the welding of the filament ends to the power supply leads 3, 4, likewise consisting of molybdenum.

The invention is not restricted to the exemplary embodiments explained in more detail above. The covering filaments 8, 8′ or molybdenum tubes 8″ are only required if especially high requirements are demanded of the vibration resistance. Instead of covering filaments 8, 8′ or molybdenum tubes 8″, in this case, however, other supporting means may also be used for the incandescent filament. For example, instead of covering filaments 8, 8′ or molybdenum tubes 8″, the power supply leads 3, 4 may be made correspondingly thick and the unwound ends 5a, 5a′ of the incandescent filament 5, 5′ connected to them may be made correspondingly short, so that the power supply leads 3, 4 already ensure a great vibration resistance.

1. A halogen lamp for motor vehicle headlights which has an electrical power consumption of between 50 watts and 100 watts and has at least one incandescent filament (5, 5′, 5″), characterized in that the at least one incandescent filament (5, 5′, 5″) is formed as a single coil, the dimensions and/or geometry of which are matched to an operating voltage of at least 20 volts, the length of the single coil having a value in the range from 4.0 mm to 6.5 mm.

2. The halogen lamp as claimed in claim 1, characterized in that the single coil (5, 5′, 5″) has at least 20 turns.

3. The halogen lamp as claimed in claim 1, characterized in that the wire diameter of the single coil (5, 5′, 5″) is between 0.11 mm and 0.14 mm.

4. The halogen lamp as claimed in claim 1, characterized in that the outside diameter of the single coil (5, 5′, 5″) is between 1.4 mm and 2.0 mm.

5. The halogen lamp as claimed in claim 1, characterized in that the ends (5a, 5a′, 5a″) of the single coil (5, 5′, 5″) are provided with supporting means (8, 8′, 8″).
